(19) United States
(12) Patent Application Publication
(10) Pub. No.: US 2025/0031598 A1
(43) Pub. Date: Jan. 30, 2025

(54) METHOD FOR OPERATING A HYDROSTATIC STEERING DEVICE FOR AN AGRICULTURAL UTILITY VEHICLE

(71) Applicant: DEERE & COMPANY, Moline, IL (US)

(72) Inventors: STEFAN BROCKE, MANNHEIM (DE); NORBERT FRITZ, ILVESHEIM (DE)

(21) Appl. No.: 18/780,665

(22) Filed: Jul. 23, 2024

(30) Foreign Application Priority Data
Jul. 26, 2023 (DE) 102023119727.4

(51) Int. Cl. A01B 69/00

(52) U.S. Cl. CPC A01B 69/007

(57) ABSTRACT

A method for operating a hydrostatic steering device for an agricultural utility vehicle, includes controlling a steering orbitrol of the hydrostatic steering device by a steering wheel via a steering column, deflecting a steering cylinder in accordance with a driver-side steering actuation of the steering wheel, detecting a steering actuation variable via a first sensor, detecting a steering position variable via a second sensor, in a normal operating mode, the control unit is configured to actuate the electric drive unit such that an actuating torque which increases continuously with the wheel steering angle is generated at the steering column and thus at the steering wheel, and in an emergency operating mode, the control unit is configured to control the electric drive unit such that an actuating torque is generated on the steering column and thus on the steering orbitrol to support driver-side steering actuation.

### CROSS-REFERENCE TO RELATED APPLICATIONS

This application claims priority to German Patent Application No. 102023119727.4, filed Jul. 26, 2023, which is hereby incorporated by reference.

### FIELD OF THE DISCLOSURE

The disclosure relates to a method for operating a hydrostatic steering device for an agricultural utility vehicle.

### BACKGROUND

Vehicle steering systems include a steering wheel, by means of which a steering metering valve in the form of an orbitrol, fed from a hydraulic pump with pressurized hydraulic fluid, can be actuated in order to control a connected hydraulic steering cylinder for adjusting steerable wheels of the vehicle.

### SUMMARY

According to a typical design, such a hydrostatic steering device comprises a steering metering valve or orbitrol, which can be set in rotation by means of a steering wheel and by means of which a double-acting steering cylinder can be deflected in accordance with a driver-side steering actuation, in that, depending on the respective actuating direction of the steering wheel and thus of the steering orbitrol, a first orbitrol connection forms an inlet connected to a hydraulic supply and a second orbitrol connection forms a return connected to a hydraulic reservoir for the hydraulic actuation of opposite working chambers of the steering cylinder. The hydraulic supply is usually a hydraulic pump fed with hydraulic fluid from the hydraulic reservoir.

As a result, the hydrostatic steering device allows comfortable steering even of heavy utility vehicles, to which end the steering cylinder is connected, for example, to an Ackermann steering system to influence the position of steerable wheels of the utility vehicle. However, owing to system-induced leaks, the pressure gradient present between the first and second orbitrol connections leads to the occurrence of hydraulic losses within the steering orbitrol, so that the volumetric flow passing through the supply is ultimately reduced by a leakage flow flowing away via the return in the direction of the hydraulic reservoir. Measured against the extent of the steering actuation, this results in a reduced extension of the steering cylinder and thus of the wheel steering angle set at the steerable wheels of the utility vehicle. In addition, the pressure gradient between the two orbitrol connections during extension generally differs in magnitude from that during retraction, which then likewise applies to the leakage flows. In turn, this means that when the steering process is complete, that is, when the steerable wheels are straightened again, the steering wheel does not fully assume its usual central or neutral position again. Over time, this results in the steering wheel position drifting in relation to the wheel steering angle, so that the two variables are no longer clearly related to each other. This can lead to disadvantages in particular if an auxiliary steering device is used to apply an actuating torque to the steering wheel that is dependent on the steering wheel position, for example to support self-centering of the steering wheel in its central or neutral position to improve the directional stability of the utility vehicle.

Furthermore, situations can occur in which the hydrostatic steering device can only be operated with considerable effort via the steering wheel. Among other things, a failure or faulty operation of the hydraulic supply or hydraulic pump feeding the steering orbitrol with hydraulic fluid is conceivable. In such a case, the steering orbitrol takes over the task of the hydraulic pump by generating a hydraulic volume flow to deflect the steering cylinder by turning the steering wheel and thus the steering orbitrol.

Against this background, it is the object of the present disclosure to provide a method for operating a hydrostatic steering device for an agricultural utility vehicle, which leads to improved operating behavior of the hydrostatic steering device.

This object is achieved by a method for operating a hydrostatic steering device for an agricultural utility vehicle having the features of one or more of the following embodiments.

In the method for operating a hydrostatic steering device for an agricultural utility vehicle, the hydrostatic steering device comprises a steering orbitrol which can be controlled by means of a steering wheel via a steering column and by means of which a steering cylinder can be deflected in accordance with a driver-side steering actuation, and an electric drive unit which can be actuated by a control unit (e.g., a controller including a processor and memory) for generating an actuating torque acting on the steering column, the control unit being supplied with a steering actuation variable which is detected by sensors on the steering column and characterizes a steering actuation exerted on the steering wheel, and a steering position variable which is detected by sensors and characterizes a wheel steering angle set by means of the steering cylinder at steerable wheels of the agricultural utility vehicle, in order, as a function of the supplied variables,
(i) in a normal operating mode, to actuate the electric drive unit in such a way that an actuating torque which increases continuously with the wheel steering angle is generated at the steering column and thus at the steering wheel, and
(ii) in an emergency operating mode, to control the electric drive unit in such a way that an actuating torque is generated at the steering column and thus at the steering orbitrol to support driver-side steering actuation.

If the hydrostatic steering device is in normal operating mode, an actuating torque can be generated that is opposite to the actuating direction of the steering wheel and increases with the amount of the wheel steering angle. At the reversal point of the wheel steering angle, the actuating torque can have a plateau-like curve that approaches zero. As a result, this means that self-centering of the steering wheel in the direction of a central or neutral position of the steerable wheels of the agricultural utility vehicle is actively supported. This also applies in the event that the driver lets go of the steering wheel. Since the actuating torque is generated in accordance with the wheel steering angle, i.e., the current position of the steerable wheels, any misalignment of the steering wheel caused by drift has no influence from the outset.

If, on the other hand, the emergency operating mode is present, a constant actuating torque that corresponds to the actuating direction of the steering wheel and is independent of the amount of the wheel steering angle can be generated, with the aim that this is less than or equal to a maximum actuating torque. The maximum actuating torque can be dimensioned such that the hydrostatic steering device can be actuated via the steering wheel with a reasonable amount of force.

The emergency operating mode is intended, among other things, for the failure or faulty operation of the hydraulic supply of the hydrostatic steering device. This is typically a hydraulic pump fed from a hydraulic reservoir with hydraulic fluid.

The steering actuation variable is, for example, a steering wheel angle or an actuation torque acting on the steering wheel, which is detected by sensor technology using an angle sensor or torque sensor assigned to the steering column.

Furthermore, the steering control variable is given either directly by the wheel steering angle detected at the steerable wheels by means of an angle sensor or indirectly by an auxiliary variable that is clearly related to the wheel steering angle, such as a deflection occurring at the steering cylinder. The latter is detected by means of a position or travel sensor provided on the steering cylinder.

The data provided by the respective sensors is made available or supplied to the control unit, for example via a CAN bus communicating with a vehicle control unit.

Advantageous developments of the method according to the disclosure can be found in one or more of the embodiments herein.

The normal operating mode can be supplemented by a further function in that the gradient of the actuating torque generated in normal operating mode is increased abruptly by the control unit when a maximum wheel steering angle is reached. This can also be provided in the event that evaluation of the steering actuation variable or steering control variable shows that the steering wheel angle changes without a change in the wheel steering angle being observed at the same time as a reaction.

In both cases, the increase takes place in such a way that an artificial end stop is generated in relation to further steering actuation. This takes into account the fact that the steering orbitrol would otherwise continue to rotate due to leakage and thus “over-rotate” even when the steering cylinder is in one of its two end positions and a further deflection or increase in the wheel steering angle is not possible for this reason. The same applies in the event that the wheel steering angle is limited by the mechanically available travel of the steerable wheels.

Furthermore, it may be provided that the actuating torque generated in normal operating mode is modified by the control unit depending on dynamic driving parameters. These parameters include, for example, the current driving speed of the agricultural utility vehicle, the amount of actuating torque being typically increased with increasing driving speed. This realizes the function of a so-called parameter steering.

The normal operating mode can be selected manually via an operating terminal connected to the control unit. In this context, it is also conceivable to adapt the steering characteristics to the individual driver, in particular the course (especially the gradient) of the actuating torque applied to the steering wheel depending on the wheel steering angle. A field operating mode can also be selected in which the control unit regulates the actuating torque at the steering column to a negligible amount by actuating the electric drive unit accordingly. This results in a steering characteristic that is substantially free of resistance or force for the driver.

By contrast, the emergency operating mode can be triggered automatically by the control unit if a failure or faulty operation of the hydraulic supply to the hydrostatic steering device is detected. Such a condition can be detected by a self-diagnosis system and transmitted to the control unit as a corresponding error message.

The above and other features will become apparent from the following detailed description and accompanying drawings.

### BRIEF DESCRIPTION OF THE DRAWINGS

The method according to the disclosure will be explained in more detail hereinafter on the basis of the appended drawings. Component parts of equivalent or comparable function are identified by the same reference signs. In the drawings:

FIG. 1 shows a schematic representation of a hydrostatic steering device for an agricultural utility vehicle;

FIG. 2a shows an exemplary curve of an actuating torque generated at a steering wheel of the hydrostatic steering device according to FIG. 1 in a normal operating mode;

FIG. 2b shows a control circuit for generating the actuating torque shown in FIG. 2a in normal operating mode;

FIG. 3a shows an exemplary curve of an actuating torque generated at the steering wheel of the hydrostatic steering device according to FIG. 1 in an extended normal operating mode;

FIG. 3b shows a control circuit for generating the actuating torque shown in FIG. 3a in extended normal operating mode;

FIG. 4a shows an exemplary curve of an actuating torque generated at the steering wheel of the hydrostatic steering device according to FIG. 1 in an emergency operating mode; and

FIG. 4b shows a control circuit for generating the actuating torque shown in FIG. 4a in emergency operating mode.

### DETAILED DESCRIPTION

The embodiments or implementations disclosed in the above drawings and the following detailed description are not intended to be exhaustive or to limit the present disclosure to these embodiments or implementations.

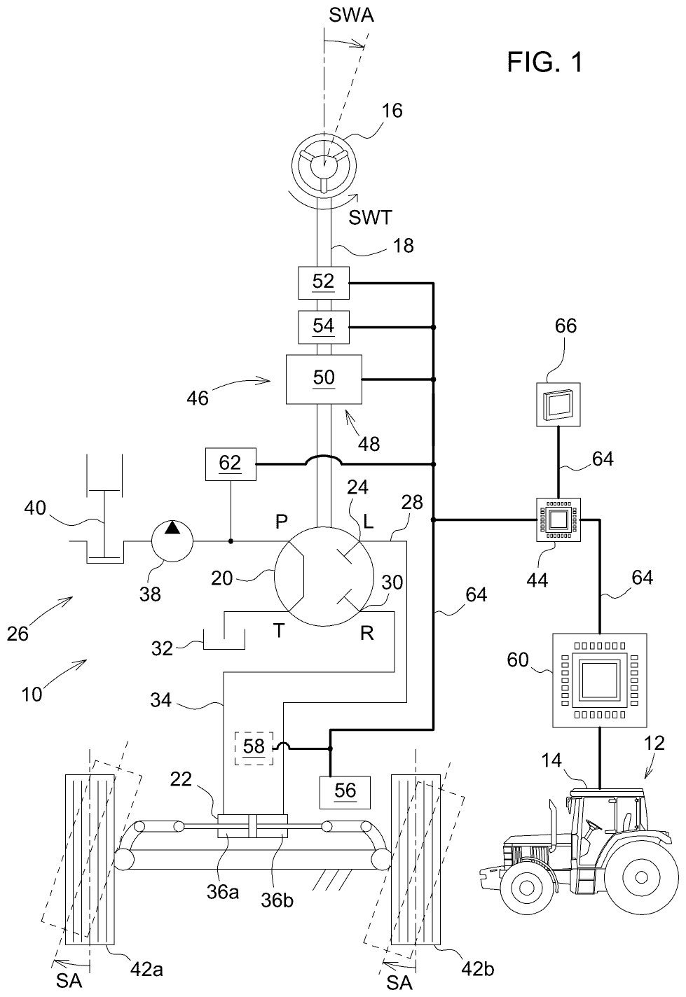

FIG. 1 shows a schematically illustrated hydrostatic steering device 10 for an agricultural utility vehicle 12, with the aid of which the mode of operation of the method according to the disclosure is to be explained in greater detail. The agricultural utility vehicle 12 is, for example, an agricultural tractor 14.

The hydrostatic steering device 10 comprises a steering metering valve or orbitrol 20 which can be controlled by means of a steering wheel 16 via a continuous steering column 18 and by means of which a double-acting steering cylinder 22 can be deflected in accordance with a driver-side steering actuation, in that, depending on the respective actuating direction of the steering wheel 16 and thus of the steering orbitrol 20, a first orbitrol connection 24 forms an inlet 28 connected to a hydraulic supply 26 and a second orbitrol connection 30 forms a return 34 connected to a hydraulic reservoir 32 for the hydraulic actuation of opposite working chambers 36a, 36b of the steering cylinder 22. The hydraulic supply 26 is in this case a hydraulic pump 38 fed with hydraulic fluid from the hydraulic reservoir 32 and driven by a vehicle engine 420.

When the operation direction of the steering wheel 16 changes, the function of the two orbitrol connections 24, 30 as supply and return 28, 34 reverses, wherein the scope of the steering operation determines the magnitude of the volumetric flows conveyed through the steering orbitrol 20. In this way, the steering cylinder 22 can be extended in accordance with the two possible driving directions of the agricultural utility vehicle 12 for corresponding actuation of steerable wheels 42a, 42b.

As can also be seen in FIG. 1, an auxiliary steering device 46, which can be actuated by a control unit 44 (e.g., a controller including a processor and memory), is provided in the form of an electric drive unit 48, by means of which an actuating torque SWT acting on the steering column 18 can be generated. The latter is generated by applying a drive torque superimposed on a driver-side steering torque to the steering column 18 by means of the electric drive unit 48. In the present case, the electric drive unit 48 is a steering column motor 50 with a fixed gear ratio.

In addition, sensor technology is used to detect a steering actuation variable, which characterizes a steering actuation exerted on the steering wheel 16 in the form of a steering wheel angle SWA or the actuation torque SWT acting on the steering column 18 and thus on the steering wheel 16. A first angle sensor 52 or torque sensor 54 assigned to the steering column 18 is used for sensor-based detection of the steering wheel angle SWA or the actuating torque SWT.

In addition, sensor technology is used to detect a steering control variable, which characterizes a wheel steering angle SA set by means of the steering cylinder 22 on the steerable wheels 42a, 42b of the agricultural utility vehicle 12.

The steering control variable is given either directly by the wheel steering angle SA detected at the steerable wheels 42a, 42b by means of a second angle sensor 56 or indirectly by an auxiliary variable that is clearly related to the wheel steering angle SA, such as a deflection occurring at the steering cylinder 22. The latter is optionally detected by means of a position or travel sensor 58 provided on the steering cylinder 22 (shown in dashed lines in FIG. 1).

The data provided by the respective sensors 52, 54, 56, 58 is made available or supplied to the control unit 44 via a CAN bus 62 communicating with a vehicle control unit 60. Various operating modes are executed by the control unit 44 on the basis of the supplied variables:

### Normal Operating Mode

In a normal operating mode, the electric drive unit 48 is actuated by the control unit 44 in such a way that an actuating torque SWT which increases continuously with the wheel steering angle SA and counteracts steering actuation is generated at the steering column 18 and thus at the steering wheel 16.

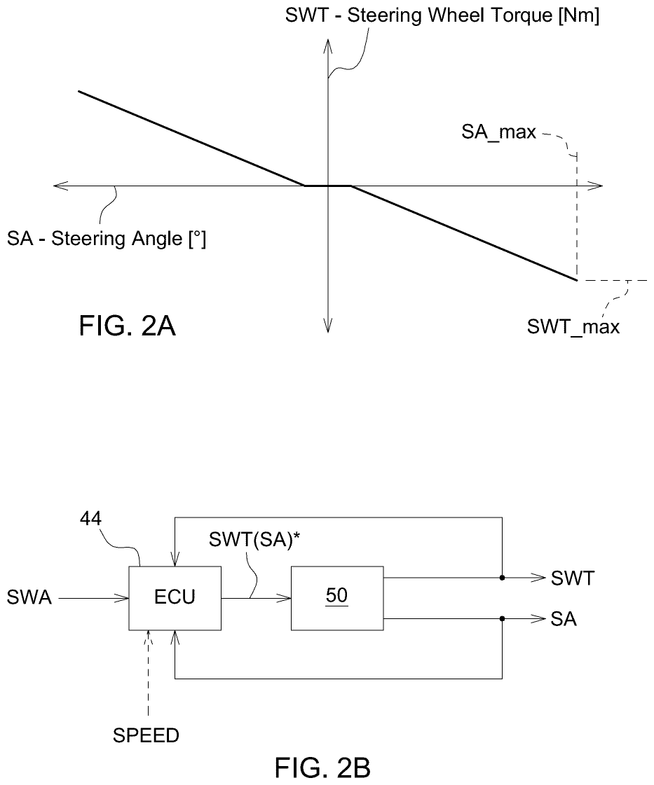

The relationship between the actuating torque SWT and the wheel steering angle SA is illustrated by way of example in FIG. 2a, wherein an actuating torque SWT is generated that is opposite to the actuating direction of the steering wheel 16 and increases continuously or steadily with the amount of the wheel steering angle SA (up to maximum values SA_max or SWT_max). In the region of a reversal point of the wheel steering angle SA (SA □ 0°), the actuating torque SWT has a plateau-like curve that approaches zero. As a result, this means that self-centering of the steering wheel 16 in the direction of a central or neutral position of the steerable wheels 42a, 42b of the agricultural utility vehicle 12 is actively supported.

FIG. 2b illustrates a control circuit realized by means of the control unit 44 for generating the actuating torque SWT in normal operating mode. Accordingly, the actuating torque SWT detected by the torque sensor 54 on the steering wheel 16 is adjusted in accordance with a setpoint value SWT (SA)* calculated by the control unit 44. The setpoint value SWT (SA)* is calculated in dependence on the respective actuating direction of the steering wheel 16, which results from the sign of the steering wheel angle SWA detected by the first angle sensor 52 and the wheel steering angle SA detected directly by the second angle sensor 56 or indirectly by the position or travel sensor 58.

Optionally, it is provided that the actuating torque SWT generated in normal operating mode is modified by the control unit 44 in dependence on dynamic driving parameters. These parameters include, for example, a current driving speed SPEED of the agricultural utility vehicle 12 that can be called up via the CAN bus 62, the amount of actuating torque SWT being increased with increasing driving speed SPEED. This realizes the function of a so-called parameter steering.

The normal operating mode can be selected manually via an operating terminal 64 connected to the control unit 44 (see FIG. 1). The control terminal 64 can also be used to adapt the steering characteristics to the individual driver, more specifically the course (especially the gradient) of the actuating torque SWT applied to the steering wheel 16 depending on the wheel steering angle. Optionally, a field operating mode can be selected in which the control unit 44 regulates the actuating torque SWT on the steering column 18 to a negligible amount (SWT □ 0 Nm) by actuating the electric drive unit 48 accordingly. This results in a steering characteristic that is substantially free of resistance or force for the driver.

### Extended Normal Operating Mode

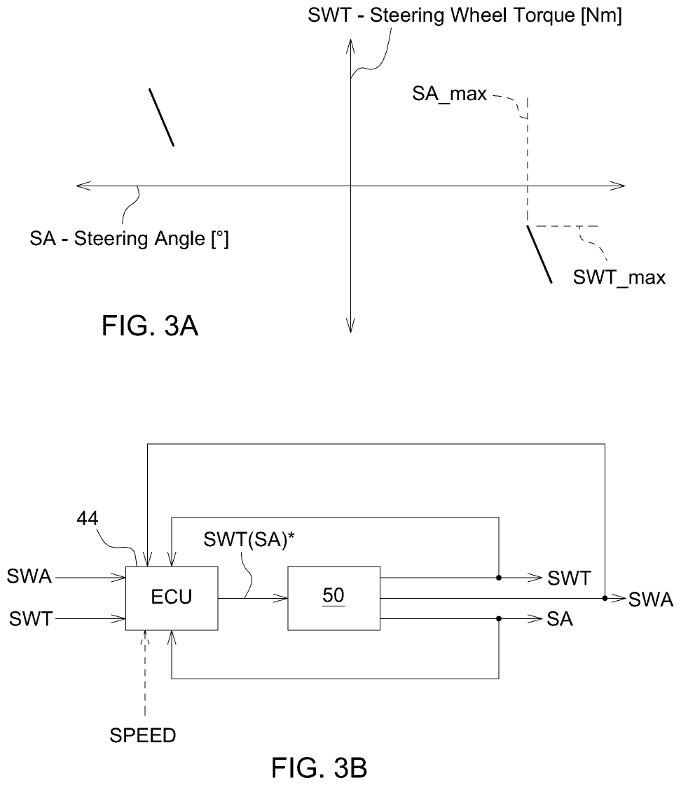

The normal operating mode can be supplemented by a further function in that the gradient of the actuating torque SWT generated in normal operating mode is increased abruptly by the control unit 44 when a maximum wheel steering angle SA_max is reached in accordance with the curve shown in FIG. 3a. This is also provided in the event that evaluation of the steering actuation variable or steering control variable shows that the steering wheel angle SWA changes without a change in the wheel steering angle SA being observed at the same time as a reaction, i.e. if ΔSWA >0, ΔSA=0 is fulfilled.

In both cases, the increase takes place in such a way that an artificial end stop is generated in relation to further steering actuation. This takes into account the fact that the steering orbitrol 20 would otherwise continue to rotate due to leakage and thus “over-rotate” even when the steering cylinder 22 is in one of its two end positions and a further deflection or increase in the wheel steering angle SA is not possible for this reason. The same applies in the event that the wheel steering angle SA is limited by the mechanically available travel of the steerable wheels 42a, 42b.

The associated control circuit is shown in FIG. 3b, wherein this provides additional monitoring of the wheel steering angle SA with regard to reaching the maximum wheel steering angle SA_max as well as a change in the steering wheel angle SWA or the wheel steering angle SA compared to that in FIG. 2b.

### Emergency Operating Mode

In an emergency operating mode, the electric drive unit 48 is actuated by the control unit 44 in such a way that an actuating torque SWT is generated at the steering column 18 and thus at the steering orbitrol 20 to support steering actuation by the driver.

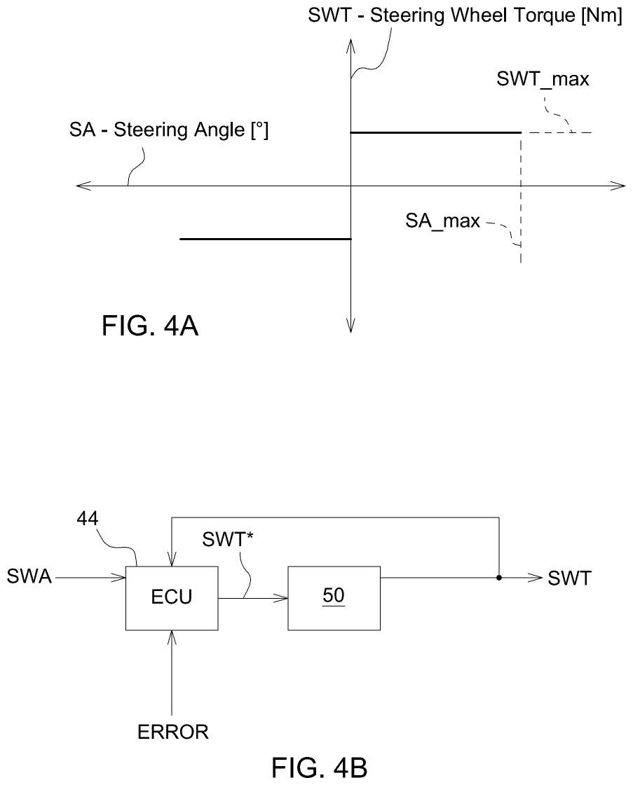

The relationship between the actuating torque SWT and the wheel steering angle SA is illustrated by way of example in FIG. 4a, wherein a constant actuating torque SWT that corresponds to the actuating direction of the steering wheel 16 and is independent of the amount of the wheel steering angle SA is generated, specifically with the aim that this is less than or equal to a maximum actuating torque SWT_max. The maximum actuating torque SWT_max is dimensioned such that the hydrostatic steering device 10 can be actuated via the steering wheel 16 with a reasonable amount of force.

The emergency operating mode is automatically triggered by the control unit 44 if a failure or faulty operation of the hydraulic supply 26 to the hydrostatic steering device 10 is detected. Such a state is detected by a self-diagnosis system of the vehicle control unit 60, among other things by evaluating the data of a pressure sensor 62 detecting a delivery pressure of the hydraulic pump 38, and is transmitted to the control unit 44 as a corresponding error message ERROR via the CAN bus 64 (see FIG. 4b).

Based on the control loop shown in FIG. 4b, the actuating torque SWT detected by the torque sensor 54 on the steering wheel 16 is adjusted in accordance with a setpoint value SWT* determined by the control unit 44. The setpoint value SWT* is also determined here in dependence on the respective actuating direction of the steering wheel 16, which in turn results from the steering wheel angle SWA detected by the first angle sensor 52.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the any use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A method for operating a hydrostatic steering device for an agricultural utility vehicle, comprising:
controlling a steering orbitrol of the hydrostatic steering device by a steering wheel via a steering column;
deflecting a steering cylinder in accordance with a driver-side steering actuation of the steering wheel;
detecting a steering actuation variable via a first sensor on the steering column which indicates a steering actuation exerted on the steering wheel;
detecting a steering position variable via a second sensor which indicates a wheel steering angle set by the steering cylinder at steerable wheels of the agricultural utility vehicle;
actuating an electric drive unit via a control unit for generating an actuating torque acting on the steering column, the control unit receiving the steering actuation variable and the steering position variable;
in a normal operating mode, as a function of the steering actuation variable and the steering position variable, the control unit is configured to actuate the electric drive unit such that an actuating torque which increases continuously with the wheel steering angle is generated at the steering column and thus at the steering wheel; and
in an emergency operating mode, as a function of the steering actuation variable and the steering position variable, the control unit is configured to control the electric drive unit such that an actuating torque is generated on the steering column and thus on the steering orbitrol to support driver-side steering actuation.

2. The method of claim 1, wherein the gradient of the actuating torque generated in normal operating mode is increased abruptly by the control unit when one of a maximum wheel steering angle is reached or in the event that the steering wheel angle changes without simultaneous change of the steering wheel angle.

3. The method of claim 1, wherein the actuating torque generated in normal operating mode is modified by the control unit in dependence on dynamic driving parameters.

4. The method of claim 1, wherein the normal operating mode can be selected manually via an operating terminal connected to the control unit.

5. The method of claim 4, wherein the course of the actuating torque applied to the steering wheel depending on the wheel steering angle can be adapted via the operating terminal.

6. The method of claim 1, wherein the emergency operating mode is automatically triggered by the control unit when one of a failure or faulty operation of the hydraulic supply to the hydrostatic steering device is detected.

7. A system for operating a hydrostatic steering device for an agricultural utility vehicle, comprising:
a steering orbitrol controlled by a steering wheel via a steering column;
a steering cylinder deflected with a driver-side steering actuation of the steering wheel;
an electric drive unit actuated via a control unit for generating an actuating torque acting on the steering column, the control unit receiving a steering actuation variable which is detected by a first sensor on the steering column and indicates a steering actuation exerted on the steering wheel, and a steering position variable which is detected by a second sensor and indicates a wheel steering angle set by the steering cylinder at steerable wheels of the agricultural utility vehicle;
in a normal operating mode, as a function of the steering actuation variable and the steering position variable, the control unit is configured to actuate the electric drive unit in such a way that an actuating torque which increases continuously with the wheel steering angle is generated at the steering column and thus at the steering wheel; and
in an emergency operating mode, as a function of the steering actuation variable and the steering position variable, the control unit is configured to control the electric drive unit in such a way that an actuating torque is generated on the steering column and thus on the steering orbitrol to support driver-side steering actuation.

8. The system of claim 7, wherein the gradient of the actuating torque generated in normal operating mode is increased abruptly by the control unit when one of a maximum wheel steering angle is reached or in the event that the steering wheel angle changes without simultaneous change of the steering wheel angle.

9. The system of claim 7, wherein the actuating torque generated in normal operating mode is modified by the control unit in dependence on dynamic driving parameters.

10. The system of claim 7, wherein the normal operating mode can be selected manually via an operating terminal connected to the control unit.

11. The system of claim 10, wherein the course of the actuating torque applied to the steering wheel depending on the wheel steering angle can be adapted via the control terminal.

12. The system of claim 7, wherein the emergency operating mode is automatically triggered by the control unit when one of a failure or faulty operation of the hydraulic supply to the hydrostatic steering device is detected.
